(19) United States
(12) Patent Application Publication
(10) Pub. No.: US 2026/0200054 A1
(43) Pub. Date: Jul. 16, 2026

(54) BEARING REMOVAL TOOL

(71) Applicant: Storm Pneumatic Tool Co., Ltd., Taichung City (TW)

(72) Inventor: Yung Yung Sun, Taichung City (TW)

(21) Appl. No.: 19/020,783

(22) Filed: Jan. 14, 2025

(51) Int. Cl. B25B 27/06; F16C 43/04

(52) U.S. Cl. CPC B25B 27/064; F16C 43/04

(57) ABSTRACT

A bearing removal tool has a body. The body has a chamber for high-pressure gas input. A striking block and an actuating shaft are provided in the chamber and driven by a high-pressure gas to interact with each other. The actuating shaft has a driving end inserted in the striking block and a working end extending out of the body. When the high-pressure gas drives the striking block to slide backward, the striking block will strike the actuating shaft to move backward. A first blocking member and a second blocking member are provided on the actuating shaft. A distance between the first blocking member and the driving end is defined as a movement distance for the striking block to slide relative to the actuating shaft. The second blocking member is fixed on the working end. When the actuating shaft is moved along with the striking block, the first blocking member and the second blocking member are driven to lean against two ends of a blocking portion, respectively. When the striking block strikes the actuating shaft backward, it will generate a backward impact force, which can be applied to bearing removal operations.

### FIELD OF THE INVENTION

The present invention relates to powered impact tools, and more particularly, to a bearing removal tool.

### BACKGROUND OF THE INVENTION

In the traditional bearing dismantling operation, the worker must hold a screwdriver with one hand to aim at the bearing to be dismantled and hold a hammer with the other hand to strike the screwdriver, so that the impact force generated by the strike can gradually remove the bearing out of the shaft hole. However, the traditional way of dismantling the bearings by manual hammering is not only time-consuming and labor-intensive but also easy to hit the hand accidentally, which often leads to injuries.

Taiwan Patent No. M573272 discloses a bearing removal device, comprising a fastening member at the front end of a shaft for tightening the inner edge of a bearing and a hammer on a shaft body of the shaft. The hammer is slidable along the shaft. When in use, the hammer is gripped by the hand and moved to hit an outwardly expanding stopper at the rear end of the shaft to create a pulling force, so that the bearing, which is tightly assembled in the shaft hole of a mechanical component, can be gradually pulled backward. Although there is no need for the operator to prepare additional hammers and screwdrivers, it also uses human power to drive the hammer to hit the stopper, so there is still the problem of time-consuming and labor-intensive. During operation, it is not easy to hold the rear end of the shaft with one hand and move the hammer to hit the stopper with the other hand. There is also a safety issue of the hand being hit by the hammer.

### SUMMARY OF THE INVENTION

The primary object of the present invention is to provide a bearing removal tool for removing a threaded element that is tightly seized in a workpiece.

In order to solve the above technical problems, the present invention provides a bearing removal tool, comprising a body, a striking block and an actuating shaft.

The body has a linear chamber and a gas intake passage therein. The chamber has a front section communicating with a front end of the body and a rear section opposite to the front section. A gas guide valve is disposed in the rear section. The gas intake passage has two ends respectively communicating with the front section and the gas guide valve. The gas guide valve is configured for switching a high-pressure gas to be input from the rear section or from the front section via the gas intake passage. The front end of the body has a blocking portion extending in an axial direction of the chamber. The blocking portion has a rear blocking surface facing the front section and a front blocking surface opposite to the rear blocking surface.

The striking block is slidably disposed in the chamber. When the high-pressure gas is input from the front section, the striking block is driven to slide toward the rear section. When the high-pressure gas is input from the rear section, the striking block is driven to slide toward the front section. The striking block has a receiving portion extending axially. A first pushing portion is formed on a rear side of the striking block, facing the rear section.

The actuating shaft has a driving end received in the receiving portion and a working end extending out of the front end of the body. A second pushing portion is formed on the driving end. The second pushing portion interacts with the first pushing portion, enabling the actuating shaft to slide toward the front section or the rear section along with the striking block. When the high-pressure gas is input from the front section to drive the striking block to slide toward the rear section, the first pushing portion of the striking block strikes the second pushing portion of the actuating shaft for driving the actuating shaft to slide toward the rear section. A first blocking member and a second blocking member are fixed on the actuating shaft. The first blocking member and the second blocking member are spaced apart. The first blocking member is located in the front section. A distance between the first blocking member and the second pushing portion is defined as a movement distance for the striking block to slide relative to the actuating shaft. The second blocking member is fixed on the working end. A distance between the second blocking member and the first blocking member is greater than an axial length of the blocking portion. When the actuating shaft is moved toward the front section, the actuating shaft drives the first blocking member to lean against the rear blocking surface. When the actuating shaft is moved toward the rear section, the actuating shaft drives the second blocking member to lean against the front blocking surface.

Embodiments of the present invention will now be described, by way of example only, with reference to the accompanying drawings.

### BRIEF DESCRIPTION OF THE DRAWINGS

FIG. 1 is an exploded view of the present invention;

FIG. 2 is a cross-sectional view of the present invention; and

FIGS. 3 to 6 are schematic views showing the operation of the present invention.

### DETAILED DESCRIPTION OF THE PREFERRED EMBODIMENTS

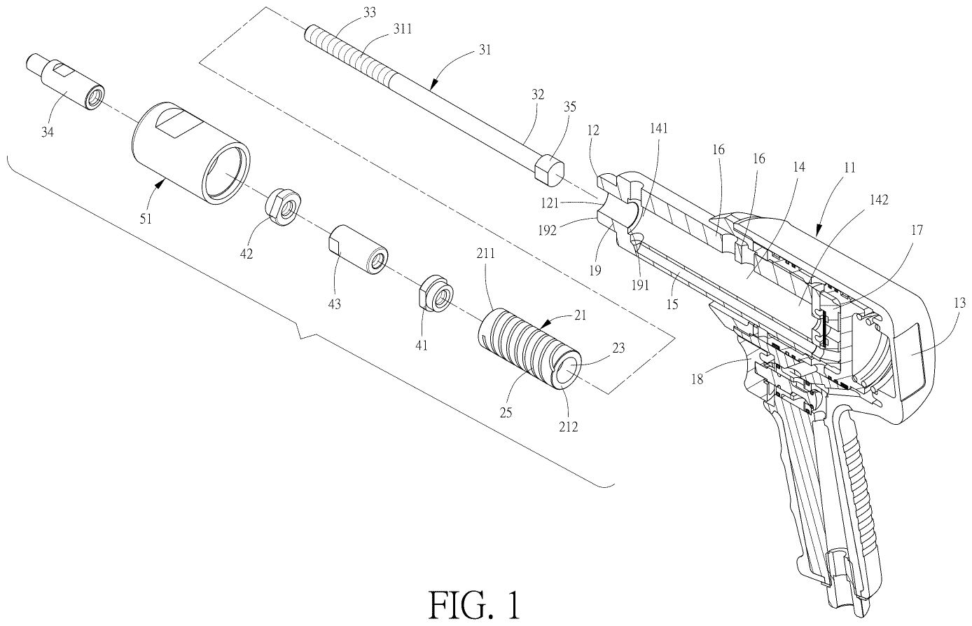

As shown in FIG. 1 through FIG. 6, the present invention discloses a bearing removal tool, comprising a body 11, a striking block 21 and an actuating shaft 31.

The body 11 has a front end 12 and a rear end 13. The body 11 may be made in the shape of a pistol or a straight cylinder. In this embodiment, the body 11 is made in the shape of a pistol as an example. The body 11 is in the form of a hollow housing, and has a linear chamber 14 and a gas intake passage 15 therein. The peripheral side of the body 11 has a plurality of vents 16 communicating with the chamber 14. The chamber 14 has a front section 141 communicating with the front end 12 of the body 11 and a rear section 142 opposite to the front section 141. A gas guide valve 17 is disposed in the rear section 142. Two ends of the gas intake passage 15 communicate with the front section 141 and the gas guide valve 17, respectively. The gas guide valve 17 is configured for switching a high-pressure gas to be input from the rear section 142 or from the front section 141 via the gas intake passage 15. A control switch 18 is disposed on the body 11 for controlling whether the high-pressure gas enters the gas guide valve 17. The front end 12 of the body 11 has a through hole 121 communicating with the outside of the body 11 and the front section 141 and a blocking portion 19 that protrudes from the inner periphery of the through hole 121 and extends in the axial direction of the chamber 14. The blocking portion 19 has a rear blocking surface 191 facing the front section 141 and a front blocking surface 192 opposite to the rear blocking surface 191. In this embodiment, the front end 12 of the body 11 is connected to a sleeve 51 extending forward and having two open ends.

The striking block 21 is slidably accommodated in the chamber 14 to separate the front section 141 and the rear section 142, so that the front section 141 and the rear section 142 of the chamber 14 are not in communication with each other. The striking block 21 can be driven by the high-pressure gas input into the chamber 14 to slide back and forth in the axial direction of the chamber 14. When the high-pressure gas is input from the front section 141, the striking block 21 will be driven to slide toward the rear section 142. When the high-pressure gas is input from the rear section 142, the striking block 21 will be driven reversely to slide toward the front section 141. The striking block 21 has a receiving portion 22 extending axially. A first pushing portion 23 is formed on a rear side 212 of the striking block 21, facing the rear section 142. In this embodiment, the first pushing portion 23 is in the form of a groove recessed in the rear side 212 of the striking block 21, and the receiving portion 22 is in the form of a perforation that is formed in a front side 211 of the striking block 21, facing the front section 141, and extends axially to communicate with the first pushing portion 23. The inner diameter of the first pushing portion 23 is greater than the inner diameter of the receiving portion 22, so that a first abutting surface 24 is formed at the junction of the first pushing portion 23 and the receiving portion 22. Furthermore, in this embodiment, the striking block 21 has a spiral groove 25 on the outer circumferential surface of the striking block 21. One end of the spiral groove 25 communicates with the rear side 212 of the striking block 21. The other end of the spiral groove 25 does not communicate with the front side 211 of the striking block 21. During most of the movement of the striking block 21 sliding forward and backward along the chamber 14, the spiral groove 25 is in communication with at least one of the vents 16 of the body 11.

The actuating shaft 31 is axially disposed in the chamber 14 and has a distance from the inner peripheral wall of the chamber 14. The actuating shaft 31 has a driving end 32 received in the receiving portion 22 and a working end 33 extending out of the front end 12 of the body 11. A tool joint 34 is provided on the working end 33. The tool joint 34 is configured for connecting a bearing engagement tool (not shown in the drawings) such as a claw or a fastening member. A second pushing portion 35 is formed on the driving end 32. The second pushing portion 35 interacts with the first pushing portion 23, enabling the actuating shaft 31 to slide toward the front section 141 or the rear section 142 along with the striking block 21. In this embodiment, the second pushing portion 35 is in the form of a protrusion that extends outward from the driving end 32 and is accommodated in the first pushing portion 23. A second abutting surface 36 is formed at the junction of the protrusion and the driving end 32. The second abutting surface 36 is configured to abut against the first abutting surface 24. When the high-pressure gas is input from the front section 141 of the chamber 14 via the gas intake passage 15 and drives the striking block 21 to slide toward the rear section 142, the first abutting surface 24 of the first pushing portion 23 of the striking block 21 will strike the second abutting surface 36 of the second pushing portion 35 of the actuating shaft 31, such that the actuating shaft 31 is driven by the striking block 21 to slide toward the rear section 142 of the chamber 14. When the high-pressure gas is input from the rear section 142 of the chamber 14, the high-pressure gas will drive the second abutting surface 36 of the actuating shaft 31 to push the first abutting surface 24 of the striking block 21, such that the striking block 21 is driven by the actuating shaft 31 to slide and return toward the front section 141 of the chamber 14.

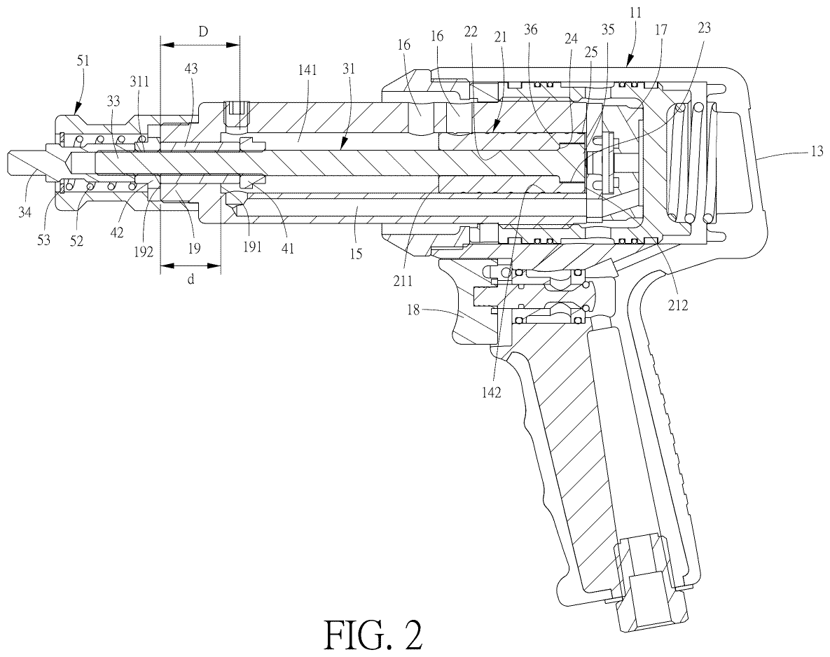

In addition, a first blocking member 41 and a second blocking member 42 are fixed on the actuating shaft 31. The first blocking member 41 and the second blocking member 42 are spaced apart. Preferably, a bushing 43 is provided between the first blocking member 41 and the second blocking member 42. The bushing 43 is fitted on the actuating shaft 31 and abuts against the first blocking member 41 and the second blocking member 42. In this embodiment, the actuating shaft 31 has a threaded section 311. The first blocking member 41, the second blocking member 42 and the bushing 43 are screwed and locked on the threaded section 311 and abut against one another. The first blocking member 41 is located in the front section 141. The distance between the first blocking member 41 and the second pushing portion 35 is defined as a movement distance for the striking block 21 to slide relative to the actuating shaft 31. The second blocking member 42 is fixed on the working end 33 and exposed outside the body 11. The distance D between the second blocking member 42 and the first blocking member 41 is greater than the axial length d of the blocking portion 19 of the body 11, such that when the actuating shaft 31 is moved toward the front section 141, the actuating shaft 31 drives the first blocking member 41 to lean against the rear blocking surface 191; when the actuating shaft 31 is moved toward the rear section 142, the actuating shaft 31 drives the second blocking member 42 to lean against the front blocking surface 192, thereby limiting the maximum travel of the actuating shaft 31 to slide forward and backward. In this embodiment, the working end 33 of the actuating shaft 31 is inserted in the sleeve 51. A spring 52 is provided in the sleeve 51 and fitted on the working end 33. One end of the spring 52 is against the second blocking member 42, and the other end of the spring 52 is against a holding member 53 in the sleeve 51. The holding member 53 is in the form of a C-shaped retainer. As shown in FIG. 2, before the high-pressure gas enters the chamber 14, the spring 52 pushes the second blocking member 42 against the front blocking surface 192, thereby ensuring smooth flow of the high-pressure gas and smooth switching of the gas guide valve 17 as well as smoother operation.

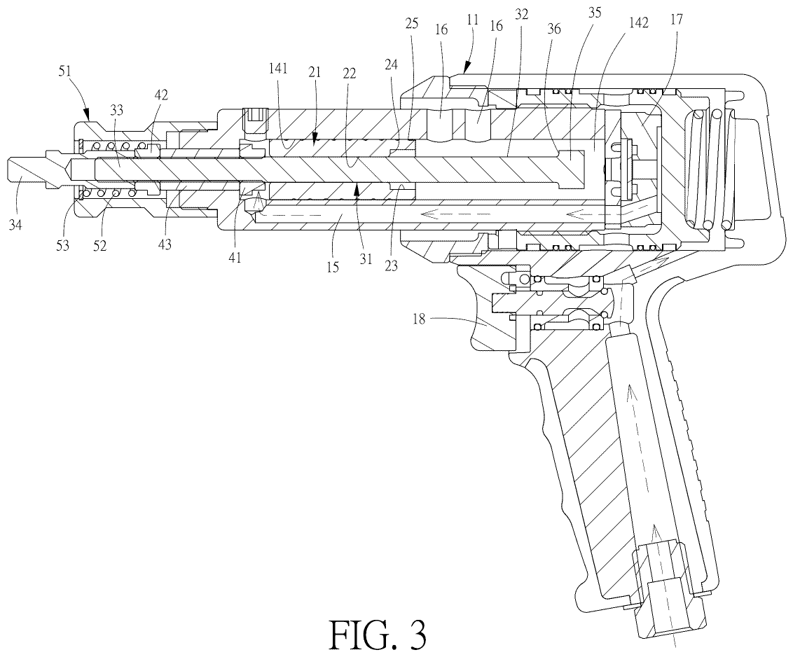

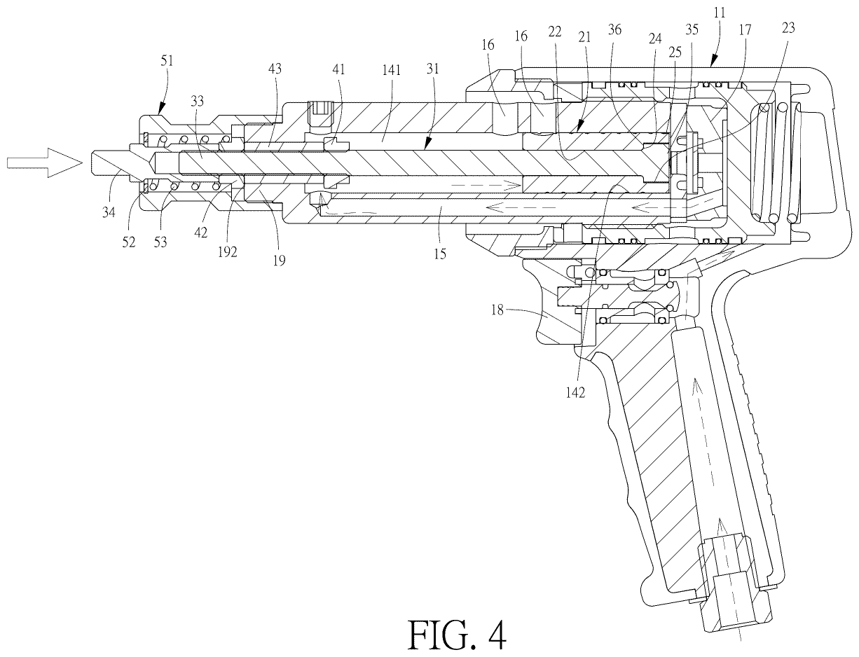

In use, as shown in FIG. 3, when the striking block 21 is in the front section 141 of the chamber 14, the first blocking member 41 on the actuating shaft 31 is driven to lean against the rear blocking surface 191 of the blocking portion 19, and the second blocking member 42 compresses the spring 52. At this time, the high-pressure gas is input to the front section 141 of the chamber 14 via the gas intake passage 15. As shown in FIG. 4, when the high-pressure gas is input to the front section 141 of the chamber 14, the striking block 21 will be driven to slide toward the rear section 142 of the chamber 14, such that the first abutting surface 24 of the first pushing portion 23 of the striking block 21 strikes the second abutting surface 36 of the second pushing portion 35 of the actuating shaft 31 to generate a backward impact force and push the actuating shaft 31 to slide toward the rear section 142, and the actuating shaft 31 slides backward until the second blocking member 42 leans against the front blocking surface 192 of the blocking portion 19. In this way, through the striking block 21 to strike the actuating shaft 31 rearward at a high speed to generate a rearward impact force, the bearing (not shown in the drawings) tightly assembled in the shaft hole can be pulled out.

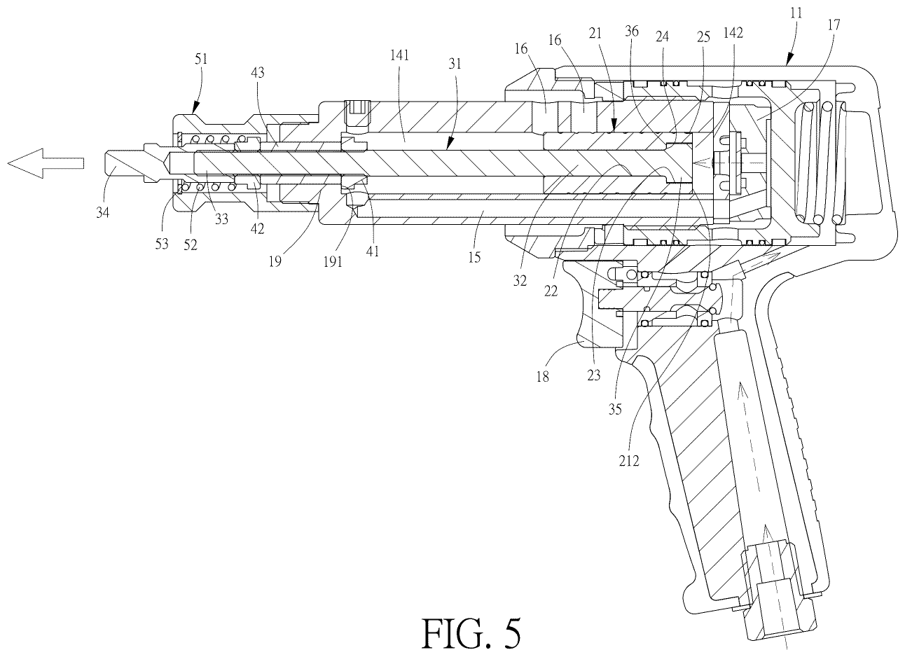

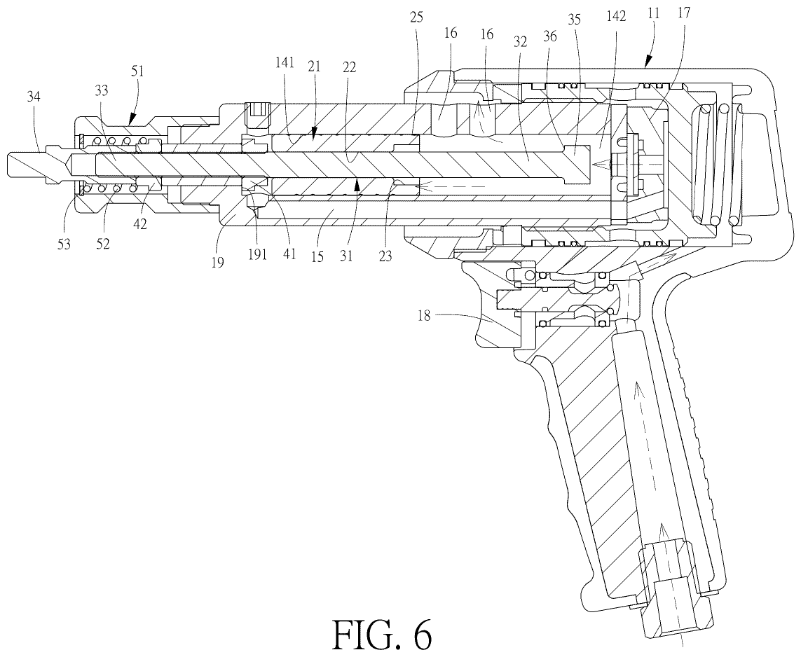

As shown in FIG. 5, when the second blocking member 42 on the actuating shaft 31 leans against the front blocking surface 192 of the blocking portion 19 and the striking block 21 is in the rear section 142 of the chamber 14, the gas guide valve 17 will switch the gas intake direction for the high-pressure gas to be input from the rear section 142 of the chamber 14. When the high-pressure gas drives the actuating shaft 31 to slide toward the front section 141 of the chamber 14, the second abutting surface 36 of the actuating shaft 31 will push the first abutting surface 24 of the striking block 21, such that the striking block 21 and the actuating shaft 31 can simultaneously slide toward the front section 141 of the chamber 14 and compress the spring again. When the first blocking member 41 on the actuating shaft 31 leans against the rear blocking surface 191 of the blocking portion 19 again, the actuating shaft 31 will stop sliding. Next, as shown in FIG. 6, after the actuating shaft 31 stops sliding, the high-pressure gas will continue to drive the striking block 21 to slide toward the front section 141 of the chamber 14 and gradually be discharged outward via the vents 16 for the striking block 21 to complete its return action. In this embodiment, when the striking block 21 slides toward the front section 141 of the chamber 14, the high-pressure gas input from the rear section 142 of the chamber 14 will be partially directed to the vents 16 via the spiral groove 25 and discharged outward through one end of the spiral groove 25 on the outer circumferential surface of the striking block 21 communicating with the rear side 212 of the striking block 21, thereby slowing down the impact force when the striking block 21 is returned. The bearing removal tool provided by the present invention has the function of maximizing the impact force when the striking block 21 slides toward the rear section 142 of the chamber 14 and minimizing the impact force when the striking block 21 slides toward the front section 141 of the chamber 14, in order to provide additional vibration damping effect.

As described above, the bearing removal tool provided by the present invention uses the high-pressure gas to drive the striking block 21 to slide back and forth in the chamber 14. When the striking block 21 slides toward the rear section 142 of the chamber 14, it will strike the actuating shaft 31 to generate an impact force to move the actuating shaft 31 backward, thereby enabling the bearing that is tightly assembled in the shaft hole to be pulled out with less effort. The bearing removal tool provided by the present invention not only eliminates the physical exertion required for the traditional way to remove the bearing manually but also effectively prevents accidental hand injuries caused by manual striking, making it very practical.

What is claimed is:

1. A bearing removal tool, comprising:
a body, having a linear chamber and a gas intake passage therein, the chamber having a front section communicating with a front end of the body and a rear section opposite to the front section, a gas guide valve being disposed in the rear section, the gas intake passage having two ends respectively communicating with the front section and the gas guide valve, the gas guide valve being configured for switching a high-pressure gas to be input from the rear section or from the front section via the gas intake passage, the front end of the body having a blocking portion extending in an axial direction of the chamber, the blocking portion having a rear blocking surface facing the front section and a front blocking surface opposite to the rear blocking surface;
a striking block, slidably disposed in the chamber, wherein when the high-pressure gas is input from the front section, the striking block is driven to slide toward the rear section, wherein when the high-pressure gas is input from the rear section, the striking block is driven to slide toward the front section, the striking block having a receiving portion extending axially, a first pushing portion being formed on a rear side of the striking block, facing the rear section;
an actuating shaft, having a driving end received in the receiving portion and a working end extending out of the front end of the body, a second pushing portion being formed on the driving end, the second pushing portion interacting with the first pushing portion, enabling the actuating shaft to slide toward the front section or the rear section along with the striking block, wherein when the high-pressure gas is input from the front section to drive the striking block to slide toward the rear section, the first pushing portion of the striking block strikes the second pushing portion of the actuating shaft for driving the actuating shaft to slide toward the rear section, a first blocking member and a second blocking member being fixed on the actuating shaft, the first blocking member and the second blocking member being spaced apart, the first blocking member being located in the front section, a distance between the first blocking member and the second pushing portion being defined as a movement distance for the striking block to slide relative to the actuating shaft, the second blocking member being fixed on the working end, a distance between the second blocking member and the first blocking member being greater than an axial length of the blocking portion, wherein when the actuating shaft is moved toward the front section, the actuating shaft drives the first blocking member to lean against the rear blocking surface, wherein when the actuating shaft is moved toward the rear section, the actuating shaft drives the second blocking member to lean against the front blocking surface.

2. The bearing removal tool as claimed in claim 1, wherein the striking block is configured to separate the front section and the rear section so that the front section and the rear section are not in communication with each other, the striking block has a spiral groove on an outer circumferential surface of the striking block, one end of the spiral groove communicates with the rear side of the striking block, and another end of the spiral groove does not communicate with a front side of the striking block, facing the front section, during movement of the striking block sliding along the chamber, the spiral groove is in communication with at least one of vents of the body.

3. The bearing removal tool as claimed in claim 1, wherein a tool joint is provided on the working end for connecting a bearing engagement tool.

4. The bearing removal tool as claimed in claim 1, wherein a bushing is provided between the first blocking member and the second blocking member, and the bushing is fitted on the actuating shaft and abuts against the first blocking member and the second blocking member.

5. The bearing removal tool as claimed in claim 4, wherein the actuating shaft has a threaded section, and the first blocking member, the second blocking member and the bushing are locked on the threaded section and abut against one another.

6. The bearing removal tool as claimed in claim 1, wherein the first pushing portion is in the form of a groove recessed in the rear side of the striking block, and the receiving portion is in the form of a perforation that is formed in a front side of the striking block, facing the front section, and extends axially to communicate with the first pushing portion, the first pushing portion has an inner diameter greater than that of the receiving portion so that a first abutting surface is formed at a junction of the first pushing portion and the receiving portion, the second pushing portion is in the form of a protrusion that extends outward from the driving end and is accommodated in the first pushing portion, a second abutting surface is formed at a junction of the second pushing portion and the driving end and configured to abut against the first abutting surface.

7. The bearing removal tool as claimed in claim 1, wherein the front end of the body has a through hole communicating with an outside of the body and the front section, and the blocking portion protrudes from an inner periphery of the through hole and extends in the axial direction of the chamber.

8. The bearing removal tool as claimed in claim 1, wherein the front end of the body is connected to a sleeve extending forward and having two open ends, the working end of the actuating shaft is inserted in the sleeve, a spring is provided in the sleeve and fitted on the working end, one end of the spring is against the second blocking member, and another end of the spring is against a holding member in the sleeve, before the high-pressure gas enters the chamber, the spring pushes the second blocking member against the front blocking surface.
